(19) United States
(12) Patent Application Publication
(10) Pub. No.: US 2005/0063631 A1
(43) Pub. Date: Mar. 24, 2005

(54) Temperature tuned arrayed waveguide grating

(76) Inventors: Mahesh R. Junnarkar, San Jose, CA (US); Anirban Bandyopadhyay, San Jose, CA (US)

Correspondence Address: TROP PRUNER & HU, PC, 8554 KATY FREEWAY, SUITE 100, HOUSTON, TX, 77024, US

(21) Appl. No.: 10/669,206

(22) Filed: Sep. 24, 2003

(51) Int. Cl. G02F 1/295; G02B 6/26; G02B 6/42

(52) U.S. Cl. 385/5; 385/17

(57) ABSTRACT

A temperature gradient may be provided across an array of waveguides in an arrayed waveguide grating. As a result, temperature tuning may be provided to adjust the characteristics of the arrayed waveguide grating. For example, the array of waveguides positioned on one side of a planar light wave circuit may be heated by a similarly configured array of heaters on the opposite side of the circuit. In some cases the number of heaters may be less than the number of arrayed waveguides. Also, each of the heaters in one embodiment may be selectively actuatable.

### BACKGROUND

This invention relates generally to arrayed waveguide gratings.

With wavelength division multiplexed optical signals, a plurality of different optical signals, each having a different wavelength, may be multiplexed over the same optical link. At intended destinations, one or more of the wavelength signals may be separated using a demultiplexing technique.

An arrayed waveguide grating, also called a phased arrayed waveguide or phaser, works like a diffraction grating. It may be fabricated as a planar structure including input and output waveguides, input and output slab waveguides, and arrayed waveguides. The length of any arrayed waveguide may differ from adjacent waveguides by constant ΔL.

The input slab waveguide splits the wavelength channels among the arrayed waveguides. Each portion of the input light traveling through the arrayed waveguide includes all the wavelengths that have entered the grating. Each wavelength in turn is individually phase shifted. As a result of that phase shift and phase shifts at the input/output slab waveguides, every portion of the light at a given wavelength acquires different phase shifts. These portions may interfere at the output slab waveguide, producing a set of maximum light intensities. The direction of each maximum light intensity depends on its wavelength. Thus, each wavelength is directed to an individual output waveguide.

Wavelength tuning an arrayed waveguide grating is done by heating or cooling the grating. The amount of temperature tuning is proportional to the mismatch between the design and the result of a particular set of process conditions. The final temperature may even be outside a range specified by the customer. The final temperature may also affect the thermal budget, especially in integrated components like variable optical attenuators, multiplexers, and optical add-drop multiplexers, to mention a few examples.

Targeting the central wavelength of an interferometer with small free spectral range demands extremely low process variation across the wafer, as well as from wafer to wafer. This is particularly important for arrayed waveguide grating-based interferometers. Any deviation of the central wavelength affects bandwidth, polarization dependent losses, and cross talk of the arrayed waveguide grating.

Existing techniques of compensating the process dependence of the arrayed waveguide grating offer relatively coarse tunability. For example, the use of multiple input waveguides with a vernier spacing and extra output waveguides to receive light with correct wavelengths has been utilized. Temperature tuning may also be done using a heater or a thermo-electric cooler to tune the refractive index of the entire array of arrayed waveguides.

Thus, there is a need for better ways to tune arrayed waveguide gratings.

### BRIEF DESCRIPTION OF THE DRAWINGS

FIG. 1 is a top plan view of one embodiment of the present invention; and

FIG. 2 is a partial, bottom plan view of the embodiment shown in FIG. 1 in accordance with one embodiment of the present invention.

### DETAILED DESCRIPTION

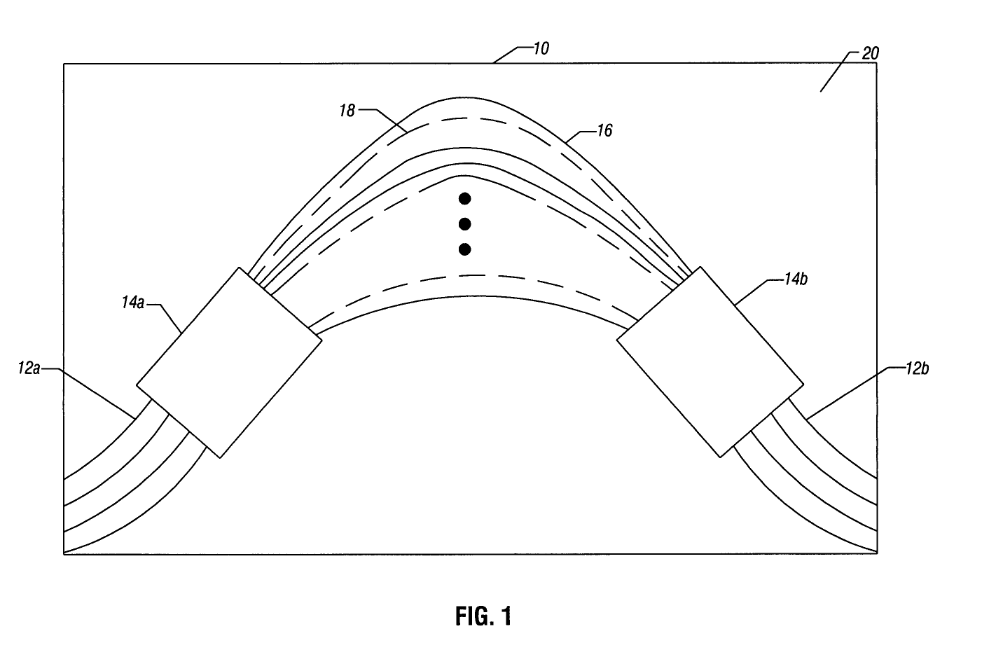

Referring to FIG. 1, the planar light wave circuit 10 may include an arrayed waveguide grating. An input waveguide 12a is coupled to an input slab waveguide 14a. The output waveguides 12b are coupled to an output slab waveguide 14b. A slab waveguide, also called a free propagation region, confines light in one dimension, usually the vertical dimension, and does not significantly confine the light in another dimension, typically the horizontal direction, such as the plane of the circuit 10.

Between the slab waveguides 14a and 14b are an array of arrayed waveguides 16. Generally, a large number of such arrayed waveguides may be provided, each of which differ in length by the amount ΔL from an adjacent waveguide. Waveguides 16 may be located on the top side 20 of the planar light wave circuit 10. On the opposite or back side 22, generally aligned with the waveguide 16, are a plurality of heaters 18. Generally the heaters 18 extend in substantially the same physical arrangement as the arrayed waveguides 16. In one embodiment, there may be less heaters 18 than arrayed waveguides 16. Adjacent heaters 18 may generate a temperature gradient across intervening, overlying waveguides 16.

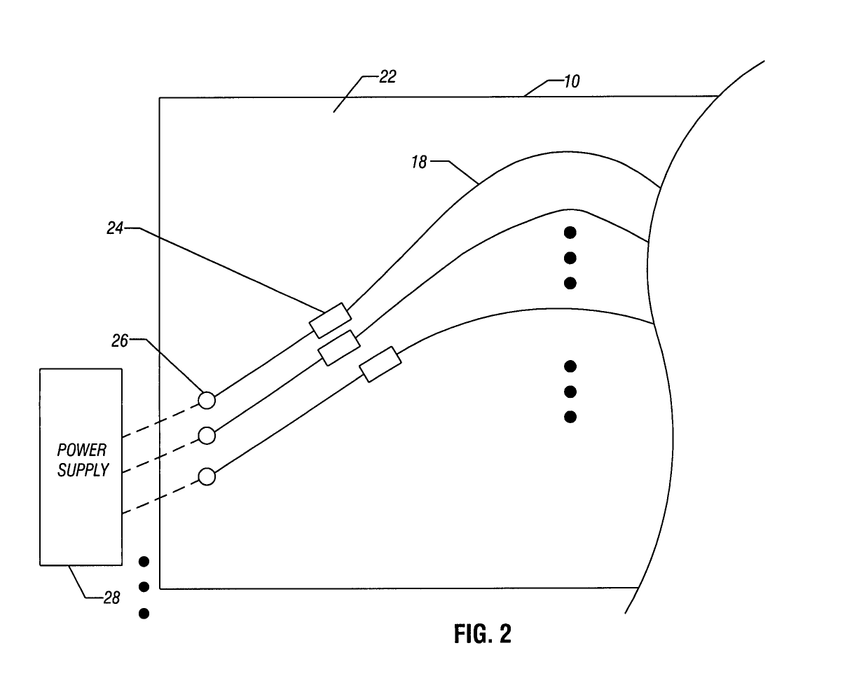

Referring to FIG. 2, on the back side 22 of the planar light wave circuit 10, may be a plurality of heaters 18. Each heater 18 may be coupled to a pad 24 in one embodiment. A pad 24 in turn may be coupled to a fusable link 26 in one embodiment. In one embodiment, the fusable links 26 may be laser openable, fusable links. A fusable link 26 may be selectively connectable to an off die power supply 28 in one embodiment. Thus, if the fusable link 26 is open, the coupled heater 18 is not operated. If the fusable link 26 is closed (or not opened by exposure to a laser beam), the particular heater 18 may be operated by the power supply 28 to create a temperature gradient on the top side 20 of the circuit 10.

Thus, in one embodiment of the present invention, temperature gradient assisted wavelength tuning may be utilized. A local temperature gradient may be artificially created across the array of waveguides 16. For example, one can tune 150 pm with a transverse gradient of 1° C. per millimeter on top of 12.5 pm/° C. tuning provided by the overall heating. The heaters 18 used for this purpose may have the capability of selectively heating filaments to generate the required gradient.

Thus, by customizing the heaters 18 through operation of the fusable links 26, one can use correct heater elements to provide average base temperatures required by an end user, while adjusting the activated heater's placement on the backside 22 of the circuit 10 to provide fine tuning. The impact of the temperature gradient on crosstalk and bandwidth may be negligible in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
forming an arrayed waveguide grating having an array of waveguides; and
arranging a plurality of heaters to provide a temperature gradient across said array of waveguides.

2. The method of claim 1 including forming an arrayed waveguide grating as a planar light wave circuit.

3. The method of claim 2 including forming said arrayed waveguide grating on the first side of said circuit and forming said heaters on the opposite side of said circuit.

4. The method of claim 3 including forming said heaters in generally the same configuration as said waveguides.

5. The method of claim 4 including positioning said heaters on the opposite side of said circuit under said waveguides and directly aligned beneath said array of waveguides.

6. The method of claim 1 including enabling said heaters to be selectively actuatable.

7. The method of claim 6 including providing laser fuses for said heaters.

8. The method of claim 7 including opening some of said fuses to select the heaters to be operated.

9. The method of claim 1 including positioning said heaters to provide a desired temperature gradient across said array of waveguides.

10. An arrayed waveguide grating comprising:
a support structure;
an array of waveguides on one side of said support structure; and
at least two heaters positioned so as to provide a temperature gradient across said array of waveguides.

11. The grating of claim 10 wherein said heaters are on one side of said structure and said array of waveguides is on the opposite side of said structure.

12. The grating of claim 11 wherein said heaters are selectively actuatable.

13. The grating of claim 10 wherein said structure is a planar light wave circuit.

14. The grating of claim 10 wherein said heaters are directly below said array of waveguides.

15. The grating of claim 10 wherein said heaters are arranged in generally the same configuration as said array of waveguides.

16. The grating of claim 15 wherein less heaters are provided than waveguides.

17. The grating of claim 10 wherein said heaters include laser actuatable fuses.

18. An arrayed waveguide grating comprising:
a support structure;
an array of waveguides; and
an array of heaters arranged in substantially the same configuration as said array of waveguides, said array of heaters being positioned on one side of said support structure and said array of waveguides being positioned on the opposite side of said support structure.

19. The grating of claim 18 wherein said heaters are selectively actuatable.

20. The grating of claim 19 wherein said heaters include actuatable fuses.

21. The grating of claim 20 wherein said fuses are laser actuatable fuses.

22. The grating of claim 18 wherein said structure is a planar light wave circuit.

23. The grating of claim 18 wherein said array of heaters is arranged substantially directly below said array of waveguides.

24. The grating of claim 23 wherein there are less heaters than waveguides.
